(19) United States
(12) Patent Application Publication
(10) Pub. No.: US 2012/0093562 A1
(43) Pub. Date: Apr. 19, 2012

(54) COMBINATION PEN WITH CORRECTION MARKER

(76) Inventor: Sandra Abplanalp, Plainfield, IN (US)

(21) Appl. No.: 12/905,042

(22) Filed: Oct. 14, 2010

(51) Int. Cl. B05C 1/00

(52) U.S. Cl. 401/17; 401/23

(57) ABSTRACT

A combination pen with correction marker providing a user with a writing utensil and a correction method in a single device. The combination pen with correction marker includes a tubular body, an ink cartridge housed within the tubular body, a pen tip connected to an end of the ink cartridge to dispenses an ink supply from within the ink cartridge, a twisting grip coupled with a plunger mechanism attached to an open end of said tubular body. The plunger mechanism moves the pen tip from an extended position and a retracted position when turning the twisting grip. The combination pen with correction marker further includes a correction reservoir fastened to an opposing end of the ink cartridge, which stores a supply of correction ink, and a sponge inserted within the correction reservoir wherein the sponge dispenses the supply of correction ink from the correction reservoir.

### BACKGROUND OF THE INVENTION

1. Field of the Invention

The present invention relates to a writing utensil equipped with a correction method to provide a user with a pen and a correction marker in a single device thus enabling the user to write and then remove errors all in one unit.

2. Description of Related Art

Permanent staples from the office supply market are writing utensils and correction ink. Writing utensils, specifically pens, are available in a plethora of options ranging from ball point, felt tip, ink well, erasable, multicolored, clicking, twisting etc. Even though not available in as many options as the pen, correction ink is offered is in many varieties, for example dispensed from a bottle, as a ribbon, or even in a pen. While these items are common office supplies they are typically sold as separate items. These multiple items may cause clutter and inconvenience for the user when continuously having to search for one item or the other while writing and editing.

Some pens are designed like a pencil and do offer an eraser built on one end. Unfortunately, this method is often insufficient. The eraser usually leaves behind marks or smears the pen ink thus creating a larger error mark than what was originally present.

As a solution a few previous patents have combined the writing utensil with the correction ink means. One example is disclosed in U.S. Pat. No. 4,600,327 which discloses a writing pen with correction fluid reservoir which combines a pen with a small reservoir of correction fluid at an opposing end. The correction fluid reservoir includes a small removable brush to dispense the correction fluid. Similarly, U.S. Pat. No. 6,357,943 discloses a ball point pen with correction supply wherein at one end of the device is a ball point pen while at the other end is a correction fluid dispenser. To use the device for correction purposes the user squeezes the correction fluid dispenser to release the correction fluid onto the paper.

While these devices are useful and do combine a writing utensil with a correction methods they may still be improved upon. For example it would be desirable to provide a pen with a correction means which does not require using a brush or having to squeeze out the correction ink for use. It would also be beneficial to provide a pen with a correction method wherein the pen has tip that twists from the chamber to alleviate the pen tip requiring a lid while not in use.

### SUMMARY OF THE INVENTION

The present invention relates to a pen combined with a correction marker that provides a writing utensil and a correction method into a single unit. It is an object of the present invention to provide a correction marker with a pen wherein the correction marker dispenses the correction fluid through a sponge.

Another object of the present invention is to provide a pen with twisting grip coupled with a plunger mechanism to extend and retract the pen tip for use by simply turning the twisting grip in one direction then the other.

In view of the foregoing disadvantages inherent in the prior art, the present disclosure describes a combination pen with correction marker to provide a user with a writing utensil and a correction method in a single device. The combination pen with correction marker comprises a tubular body, an ink cartridge housed within the tubular body, a pen tip connected to an end of the ink cartridge that dispenses an ink supply from within the ink cartridge, a twisting grip coupled with a plunger mechanism attached to an open end of said tubular body. The plunger mechanism moves the pen tip from an extended position to a retracted position when turning the twisting grip. The combination pen with correction marker further comprises a correction reservoir fastened to an opposing end of the ink cartridge, which stores a supply of correction ink, and a sponge inserted within the correction reservoir wherein the sponge dispenses the supply of correction ink from the correction reservoir.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a combination pen with correction marker in a retracted position in accordance with an exemplary embodiment of the present invention.

FIG. 2 depicts a perspective view of a combination pen with correction marker in an extended position in accordance with an exemplary embodiment of the present invention.

Like reference numerals refer to like parts throughout the description of several views of the drawings.

### DETAILED DESCRIPTION OF THE DRAWINGS

The present invention relates to a writing utensil equipped with a correction method to provide a user with a pen and a correction marker in a single device. The present invention is a combination pen with correction marker to provide a user with an improved pen with correction method. The combination pen with correction marker is a writing apparatus containing ink dispensed from one end and correction fluid dispensed from an opposing end. The present invention provides the user with immediate capabilities to correct their errors when writing. The combination pen with correction marker is designed with a correction reservoir to store a supply of correction ink. Extending from the correction reservoir is a sponge, housed partially within the correction reservoir. When needed the user simply uncovers the sponge and slides it over a portion of writing to be covered thus dispensing the correction ink. The combination pen with correction marker alleviates the need for separate pens and correction methods, to provide the user with a simple and effective way to write and clear mistakes at-will within a single device.

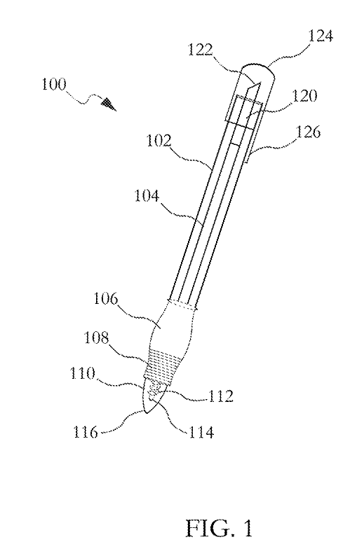

Turning now descriptively to the drawings, referring to FIG. 1, a perspective view of a combination pen with correction marker (100) is shown in a refracted position in accordance with an exemplary embodiment of the present invention. The combination pen with correction marker (100) may comprise a tubular body or a chamber to extend along an entire length of the combination pen with correction marker (100). The tubular body (102) may be composed of a hard plastic with an opaque coating or the hard plastic may be clear to enable a user to see through the tubular body (102). Centrally located within the tubular body (102) may be an ink cartridge (104). The ink cartridge (104) houses an ink supply for the combination pen with correction marker (100). The ink supply may be available in any preferred color of the user depending on their likes and preferences, for example blue, black, purple, red, green or the like. Fastened to an end of the ink cartridge (104) may be a pen tip (114) which enables the combination pen with correction marker (100) to mark and write. The pen tip (114) may comprise a ball point pen or a felt tip pen, whichever is preferred by the user.

Attached to an opening of the tubular body (102) may be a twisting grip (106). The twisting grip (106) may include a textured portion (108) at a portion closest to the pen tip (114). The textured portion (108) is where the user may comfortably grip, hold and control the combination pen with correction marker (100) during use. The twisting grip (106) may be composed of a soft rubber or sponge material to provide the user with additional comfort and support. Threaded within the twisting grip (106), beneath the textured portion (108), is a tip encasing (110). The tip encasing (110) houses the pen tip (114), and prevents the ink supply within the pen tip (114) and the ink cartridge (104) from drying out when not in use. When the user turns the twisting grip (106), the pen tip (114) extends from the tip encasing (110) through a hole (116), and then retracts when turned in an opposing direction.

Accordingly, inside the twisting grip (106) is coupled with a plunger mechanism. The plunger mechanism operates by turning the twisting grip (106) to extend and retract the pen tip (114). The user may simply turn the twisting grip (106) in a clockwise direction to extend the pen tip (114) from the opening of the tubular body (102), and then turn the twisting grip (106) in a counterclockwise direction to retract the pen tip (114). The twisting grip (106) may also be constructed to extend the pen tip (114) when turning in the counterclockwise direction, and then retract when turning in the clockwise direction.

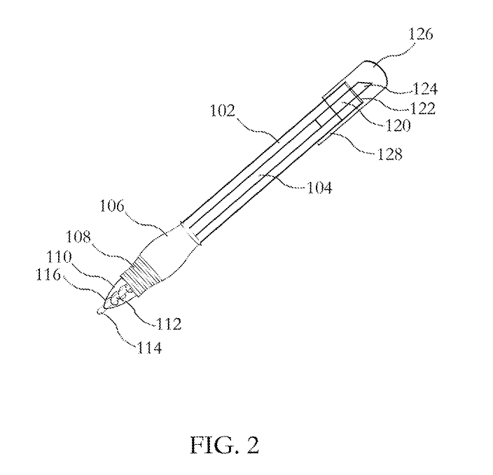

Surrounding the pen tip (114) within the tip encasing (110) is a spring (112). The spring (112) works with the plunger mechanism to enable the plunger mechanism to move the pen tip (114) from a retracted position (as shown) to an extended position (as shown in FIG. 2). The spring (112) provides tension when plunger mechanism extends the pen tip (114) from the tip encasing (110) because the extended pen tip (114) constricts the spring (112). As follows, when the plunger mechanism retracts the pen tip (114), the spring (112) expands thus raising the ink cartridge (104) and pen tip (114) into the tubular body (102).

Turning now on an opposing end of the combination pen with correction marker (100) from the twisting grip (106), is a correction reservoir (120). The correction reservoir (120) is fastened to an opposing end of the ink cartridge (104) from the pen tip (114). The correction reservoir (120) may contain a supply of correction ink. The correction ink is commonly provided in a white color but may also be available in ivory, cream, yellow or another specialized color to match the paper color used. Housed partially within the correction reservoir (120) may be a sponge (122) to absorb the correction ink. A portion of the sponge (122) extends from the correction reservoir (120) to dispense the correction ink onto the paper for use. The sponge (122) may comprise a blunt end or an angled tip (as shown) depending on the preferences of the user. The angled tip (122) may provide greater control and ease of use for the user. When the user wishes to correct or cover a mistake or portion of their paper, the correction ink may simply flow from the correction reservoir (120), through the sponge (122) and onto the paper. The correction ink is an instant drying formula to allow for fast and easy editing.

Covering the sponge (122) may be a cap (124). The cap (124) prevents the sponge (122) from drying and getting hard, and ensures that the correction ink within the correction reservoir (120) remains wet. The cap (124) may include a pocket clip (126) to attach the combination pen with correction marker (100) to an item. By clipping the combination pen with correction marker (100) to the item, the user may prevent theft or loss.

Referring now to FIG. 2, a perspective view of the combination pen with correction marker (100) is shown in an extended position in accordance with an exemplary embodiment of the present invention. The extended position illustrates the combination pen with correction marker (100) in a position ready for use. The pen tip (114) is extended from the tip encasing (110) through the hole (116). The user may freely write, draw, doodle and the like while the pen tip (114) is extended. When finished writing, the user simply turns the twisting grip (106) thereby activating the plunger mechanism to retract the pen tip (114) back within the tip encasing (110) to be stored in the retracted position (as shown in FIG. 1).

For use the combination pen with correction marker (100) is a simple device providing writers with the convenience of always having correction fluid available. The user does not have to worry about making mistakes while writing, because they may easily correct the errors. The users readily have correction fluid available thus the stress caused to some users when writing with a pen is pacified.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A combination pen with correction marker comprising:
a tubular body extending an entire length of said combination pen with correction marker;
an ink cartridge housed within said tubular body;
a pen tip connected to an end of said ink cartridge, where said pen tip dispenses an ink supply from within said ink cartridge;
a twisting grip coupled with a plunger mechanism attached to an open end of said tubular body, where said plunger mechanism moves said pen tip from an extended position and a retracted position when turning said twisting grip;
a correction reservoir fastened to an opposing end of said ink cartridge, where said correction reservoir stores a supply of correction ink; and
a sponge inserted within said correction reservoir wherein said sponge dispenses said supply of correction ink from said correction reservoir.

2. The combination pen with correction marker of claim 1, wherein said twisting grip includes a tip encasing to house said pen tip to prevent said supply of ink from drying.

3. The combination pen with correction marker of claim 2, wherein said tip encasing includes a hole to enable said pen tip to extend and retract from said extended position to said retracted position.

4. The combination pen with correction marker of claim 1, wherein said twisting grip includes a textured portion.

5. The combination pen with correction marker of claim 1, wherein said sponge includes an angled tip.

6. The combination pen with correction marker of claim 1, wherein said sponge has a blunt tip.

7. The combination pen with correction marker of claim 1, wherein said sponge is covered by a cap to prevent said sponge from hardening and to prevent said supply of correction ink from drying within said correction reservoir.

8. The combination pen with correction marker of claim 7, wherein said cap includes a pocket clip.
